(19) United States
(12) Patent Application Publication
(10) Pub. No.: US 2009/0215960 A1
(43) Pub. Date: Aug. 27, 2009

(54) Thermoplastic Resin Having Uniform Composition and Narrow Molecular Weight Distribution, and Method for Preparing the Same

(75) Inventors: Young Sub JIN, Seoul (KR); Byeong Do LEE, Gwangjugwangyeok-si (KR); Jae Keun HONG, Gunpo-si (KR); Hwan Seok PARK, Anyang-si (KR)

Correspondence Address: SUMMA, ADDITON & ASHE, P.A., 11610 NORTH COMMUNITY HOUSE ROAD, SUITE 200, CHARLOTTE, NC, 28277, US

(73) Assignee: CHEIL INDUSTRIES INC., Gumi-si (KR)

(21) Appl. No.: 12/432,790

(22) Filed: Apr. 30, 2009

Related U.S. Application Data
(63) Continuation-in-part of application No. PCT/KR2006/005695, filed on Dec. 26, 2006.

(30) Foreign Application Priority Data
Nov. 10, 2006 (KR) 10-2006-110994

(51) Int. Cl. C08F 2/02

(52) U.S. Cl. 525/94; 526/65

(57) ABSTRACT

A method for preparing a thermoplastic resin is disclosed, which includes consecutively polymerizing a mixed raw material comprising a (meth)acrylic acid alkyl ester, an aromatic vinyl monomer and a unsaturated nitrile monomer in a plurality of serially connected reactors while controlling polymerization conversion in each reactor to be about 40% or less. The invention also relates to a transparent ABS resin composition which employs the thermoplastic resin as a matrix resin.

### CROSS-REFERENCE TO RELATED APPLICATIONS

This non-provisional application is a continuation-in-part application of PCT Application No. PCT/KR2006/005695, filed Dec. 26, 2006, pending, which designates the U.S. and which is hereby incorporated by reference in its entirety, and claims priority therefrom under 35 USC Section 120. This application also claims priority under 35 USC Section 119 from Korean Patent Application No. 10-2006-110994, filed Nov. 10, 2006, the entire disclosure of which is also hereby incorporated by reference.

### FIELD OF THE INVENTION

The present invention relates to a method of preparing a thermoplastic resin having uniform composition and narrow molecular weight distribution.

### BACKGROUND OF THE INVENTION

In general, ABS resin has good physical properties such as the processability of styrene, the toughness and chemical resistance of acrylonitrile, and the impact resistance of butadiene, and is excellent in appearance. Therefore, ABS resins have been widely used in automobiles, electronic and electrical appliances, office appliances, electronic goods, toys, stationery goods and the like. However, ABS resins have limited use in applications in which transparency is required since ABS resins are typically opaque.

Other transparent resins such as styrene-acrylonitrile (SAN), polycarbonate (PC), polystyrene (PS), polymethyl methacrylate (PMMA)) and the like, can be used in applications requiring transparency. However, although SAN, PS and PMMA resins have superior transparency and cost, they have poor impact resistance, which restricts their use in many applications. Although polycarbonate resin can have superior transparency and impact resistance, it can have low chemical resistance and high cost, thereby limiting its use as well. Therefore, efforts have focused on the development of transparent ABS resins that satisfy both transparency and impact resistance requirements.

Transparent ABS resins can be produced by minimizing the diffusion of light in the visible wavelength region by adjusting the size of the rubber particles employed in ABS resin. Another method for producing transparent ABS resin matches the refractive indices of the dispersed phase (rubber) and the continuous phase (matrix resin) to minimize diffusion and light refraction at the interface between the dispersed phase and the continuous phase.

Korea Patent Nos. 0429062, 0507336, 0519116, Korea Patent Laid-open No. 2006-016853, U.S. Pat. No. 4,767,833, U.S. Patent Publication No. 2006/0041062, and Japanese Patent Laid-open No. 2006-63127 disclose a transparent ABS resin prepared by adjusting the difference in refractive index between the dispersed phase and the matrix resin to not more than 0.005. The matrix resins prepared from the above patents have a conversion of 95% or more. However, the composition of polymer produced in an initial polymerization step may be different from the composition of polymer produced in a final polymerization step, because the reactivities of monomers differ from one another at different stages of polymerization.

G. Odian (Principles of Polymerization) and M. Hocking (J. of Polymer Science: Part A, vol. 34, pp. 2481-2497, 1996) proposed an equation estimating the composition of a polymer prepared by radical polymerization using a monomer mixture comprising at least 3 kinds of monomers. This equation estimates polymer composition by using a relative ratio of reaction rate of each monomer in the monomer mixture and demonstrates that the monomer composition cannot be the same as the polymer composition except in an azeotropic composition. That is, a monomer having a fast reaction rate is rapidly converted into polymer, so that the polymer from the monomer having a fast reaction rate will primarily exist at the initial polymerization step. On the other hand, as the polymerization proceeds to the last step, polymer from a monomer having a slow reaction rate will primarily exist. When the conversion reaches 95% or more, most monomers added thereto are converted into a polymer and the average composition of the polymer is similar to the monomer composition at the initial step. However, it is estimated that the polymers may have different compositions depending on the point at which the polymer is produced. Therefore, although the average refractive index of the matrix resin from the above patents may be matched with that of the dispersed phase (rubber), the refractive index of the matrix is partially different from that of the rubber, which tends to adversely affect transparency.

Many methods have been proposed to improve impact strength of transparent ABS resin by using rubber particles obtained from various techniques. However, no technique for improving impact resistance based on the property of the matrix resin has been found. The molecular weight distribution of the matrix resin obtained from the above technology is typically more than 2.3. However, as the molecular weight distribution becomes broader, impact strength deteriorates due to the presence of low molecular weight polymer.

### SUMMARY OF THE INVENTION

The present inventors have developed a method of preparing a thermoplastic resin having uniform composition and narrow molecular weight distribution. More particularly, the present invention relates to a method of preparing a thermoplastic resin having uniform composition and narrow molecular weight distribution using a continuous polymerization process to produce a matrix resin for a transparent ABS resin. The present invention also provides a transparent ABS resin composition that includes the resultant thermoplastic resin as a matrix resin.

One aspect of the invention provides a method for preparing a thermoplastic resin, which comprises consecutively polymerizing a mixed raw material comprising a (meth)acrylic acid alkyl ester, an aromatic vinyl monomer and an unsaturated nitrile monomer in a plurality of serially connected reactors while controlling polymerization conversion in each reactor to be about 40% or less.

In exemplary embodiments of the invention, the plurality of reactors comprises about 2 to 6 reactors.

In exemplary embodiments of the invention, the polymerization conversion is controlled through reaction temperature, retention time, and/or the types and amounts of polymerization initiator.

In exemplary embodiments of the invention, a monomer selected from the group consisting of (meth)acrylic acid alkyl esters, aromatic vinyl monomers, unsaturated nitrile monomers, and combinations thereof is further added to the polymer between each reactor.

In exemplary embodiments of the invention, the mixed raw material comprises up to about 0.2 parts by weight of a polymerization initiator based on 100 parts by weight of a monomer mixture.

In exemplary embodiments of the invention, the mixed raw material comprises up to about 20 parts by weight of a solvent based on 100 parts by weight of a monomer mixture.

In exemplary embodiments of the invention, the thermoplastic resin has a weight average molecular weight of about 60,000 to about 150,000, and a molecular weight distribution of about 2.3 or less.

Another aspect of the invention provides a transparent ABS resin composition which employs the foregoing thermoplastic resin as a matrix resin.

In exemplary embodiments of the invention, the transparent ABS resin composition comprises a rubber/methyl methacrylate-styrene-acrylonitrile graft copolymer.

In exemplary embodiments of the invention, the difference between the refractive index of the rubber/methyl methacrylate-styrene-acrylonitrile graft copolymer and the thermoplastic resin is about 0 to about 0.002.

### DETAILED DESCRIPTION OF THE INVENTION

The present invention now will be described more fully hereinafter in the following detailed description of the invention, in which some, but not all embodiments of the invention are described. Indeed, this invention may be embodied in many different forms and should not be construed as limited to the embodiments set forth herein; rather, these embodiments are provided so that this disclosure will satisfy applicable legal requirements.

The method of the invention includes continuously feeding a mixture of (meth)acrylic acid alkyl ester, aromatic vinyl compound and unsaturated nitrile compound into a reactor and maintaining the mixture within the reactor for a given retention time so as to polymerize the mixture, followed by continuously discharging the resultant polymer.

At least two continuous polymerization reactors are connected in series, and two to six continuous polymerization reactors can be connected in series. Further, monomer which is preferentially consumed in a large amount in a previous reactor (due to the differences in reaction rates between monomers) can be continuously added between the reactors to participate in the polymerization reaction, which enables the polymer produced from each reactor to maintain a uniform composition. As used herein, reference to continuously adding monomer between the reactors refers to adding additional monomer to the polymer stream between the reactors (i.e., to the polymer product as it is discharged from one reactor in series to the next reactor in series) or directly to the next reactor.

As a non-limiting example, for a monomer mixture of styrene, methyl methacrylate and acrylonitrile, additional styrene monomer can be added to the discharged polymer stream between reactors and/or to the next reactor in series because styrene can be more rapidly consumed in the polymerization reaction as compared to methyl methacrylate and acrylonitrile. Based on the teachings herein, the skilled artisan will understand and appreciate the types and amounts of additional monomer to add to the discharged polymer stream between reactors and/or the next reactor in series without undue experimentation.

Examples of the (meth)acrylic acid alkyl ester monomer suitable for use in the present invention may include without limitation methyl methacrylate, ethyl methacrylate, 2-ethyl hexyl methacrylate, methyl acrylate, ethyl acrylate, butyl acrylate, 2-ethyl hexyl acrylate, and the like, and combinations thereof.

Examples of the aromatic vinyl compound suitable for use in the present invention may include without limitation styrene, α-methyl styrene, and the like and combinations thereof.

Examples of the unsaturated nitrile compound suitable for use in the present invention may include without limitation acrylonitrile, methacrylonitrile, and the like, and combinations thereof.

The conversion of monomers into polymers in each continuous polymerization reactor may be controlled to be about 40% or less, for example, conversion in each reactor of about 15% to about 40%. If the conversion is more than about 40%, the composition of polymer produced from the initial polymerization step may be different from the composition of polymer produced from the last polymerization step, which can result in a small difference in refractive even though the average refractive indices are the same, thereby decreasing the transparency of the ABS resin. If the conversion is less than about 15%, it is not economical or desirable to increase the number of reactors or apparatuses involved between the reactors, although the polymer may have a homogeneous composition.

Reaction temperature, retention time, and the types and amounts of polymerization initiator may be controlled in order to maintain the conversion of polymer in each reactor to about 40%. In exemplary embodiments of the invention, the reaction temperature in each reactor can range from about 100° C. to about 150° C. In exemplary embodiments of the invention, the retention time within each reactor can range from about 0.5 to about 3.5 hours.

Examples of the polymerization initiator suitable for use in the present invention may include without limitation benzoyl peroxide, t-butyl peroxyisobutyrate, 1,1-bis(t-butylperoxy)cyclohexane, 2,2-bis(4,4-di-t-butylperoxy cyclohexane)propane, t-hexyl peroxy isopropyl monocarbonate, t-butyl peroxylaurate, t-butyl peroxy isopropyl monocarbonate, t-butyl peroxy 2-ethylhexyl monocarbonate, t-hexyl peroxybenzoate, t-butyl peroxyacetate, 2,2-bis(t-butyl peroxy)butane, t-butyl peroxybenzoate, dicumyl peroxide, 2,5-dimethyl-2,5-bis(t-butyl peroxy)hexane, t-butyl cumyl peroxide, di-t-butyl peroxide, di-t-amyl peroxide, and the like, and combinations thereof. The amount of the polymerization initiator can range from about 0 to about 1 part by weight, for example about 0.01 to about 0.2 parts by weight, based on 100 parts by weight of a monomer mixture. If the amount of polymerization initiator is more than about 1 part by weight, it can be difficult to control reaction temperature or retention time due to a sudden polymerization reaction, and the molecular weight of polymer obtained therefrom may be decreased so that the impact strength may be degraded.

In exemplary embodiments of the invention, a solvent may be optionally employed. The solvent may be used in an amount of about 20 parts by weight or less, per 100 parts by weight of the monomer mixture to decrease the viscosity of the reactant, and thereby allow it to be stirred smoothly, which can be advantageous for producing a thermoplastic resin with narrow molecular weight distribution. Examples of the solvent suitable for use in the present invention may include without limitation aromatic solvents such as ethylbenzene, benzene, toluene, xylene, etc; methyl ethyl ketone, acetone, and the like, and combinations thereof.

In the present invention, a molecular weight controlling agent can be added. An example of a molecular weight controlling agent suitable for use in the present invention includes without limitation alkyl mercaptan represented by the formula CH₃(CH₂)nSH, such as n-butylmercaptan, n-octylmercaptan, n-dodecylmercaptan, t-dodecylmercaptan, and the like, and combinations thereof.

A thermoplastic resin prepared by the method of the present invention can have a weight average molecular weight of about 60,000 to about 150,000, and a molecular weight distribution of about 2.3 or less. One of the features of the method for preparing the thermoplastic resin is that each continuous reactor is maintained under the same reaction conditions, so that the molecular weight of polymers produced from each reactor is substantially uniform.

Generally, the impact resistance of a transparent ABS resin is greatly affected by the types, sizes and shapes of rubber used therein. When the same rubber is employed, the impact resistance is affected by the molecular weight and the molecular weight distribution of the thermoplastic resin used as a matrix of the transparent ABS resin. If the weight average molecular weight of the thermoplastic resin is less than about 60,000, the impact resistance may be degraded. If the weight average molecular weight of the thermoplastic resin is more than about 150,000, the flowability may become lower, resulting in decreased processability. Further, if the molecular weight distribution, defined as the ratio of the weight average molecular weight to the number average molecular weight (Mw/Mn), is more than about 2.3, a large amount of low molecular weight resins with the same weight average molecular weight may be produced, which results in poor impact resistance.

The composition of the final thermoplastic resin prepared by the foregoing continuous polymerization comprises about 50 to about 85 parts by weight of (meth)acrylic acid alkyl ester, about 10 to about 50 parts by weight of aromatic vinyl compound and about 2 to about 15 parts by weight of unsaturated nitrile compound.

The thermoplastic resin can be employed as a matrix resin in a transparent ABS resin composition.

In exemplary embodiments of the invention, the transparent ABS resin composition comprises the foregoing thermoplastic resin and a rubber/methyl methacrylate-styrene-acrylonitrile graft copolymer. Rubber/methyl methacrylate-styrene-acrylonitrile graft copolymers useful in the present invention are known and are commercially available, and the skilled artisan will appreciate and understand the types of graft copolymers suitable for use in the present invention without under experimentation based on the disclosures herein.

In exemplary embodiments of the invention, the transparent ABS resin composition may be prepared by blending the foregoing thermoplastic resin and the rubber/methyl methacrylate-styrene-acrylonitrile graft copolymer. Conjugated diene rubber or SBR rubber may be used as the rubber.

In exemplary embodiments of the invention, the transparent ABS resin composition comprises about 50 to about 90% by weight of the foregoing thermoplastic resin and about 10 to about 50% by weight of the rubber/methyl methacrylate-styrene-acrylonitrile graft copolymer.

The difference between the refractive index of the thermoplastic resin and the rubber/methyl methacrylate-styrene-acrylonitrile graft copolymer may be about 0.008 or less, for example about 0.004 or less, and as another example about 0.002 or less. If the difference between refractive indices is more than about 0.008, the haze of the transparent ABS resin obtained therefrom may increase, thereby deteriorating transparency.

The transparent ABS resin can have a haze of about 4.5 or less as measured by a Nippon Denshoku Haze meter and an Izod impact strength according to ASTM D-256 at a sample thickness of ⅛ inch of about 13 kgf·cm/cm or more in various applications.

In exemplary embodiments of the invention, the transparent ABS resin can have a haze of about 0.1 to about 4.5 as measured by a Nippon Denshoku Haze meter and an Izod impact strength according to ASTM D-256 at a sample thickness of ⅛ inch of about 13 to about 35 kgf·cm/cm.

The invention may be better understood by reference to the following examples which are intended for the purpose of illustration and are not to be construed as in any way limiting the scope of the present invention, which is defined in the claims appended hereto. In the following examples, all parts and percentage are by weight unless otherwise indicated.

### EXAMPLES

### Preparative Example 1

100 parts by weight of a monomer mixture including 15 parts by weight of styrene, 80 parts by weight of methyl methacrylate and 5 parts by weight of acrylonitrile along with 15 parts by weight of ethylbenzene, 0.03 parts by weight of di-t-amyl peroxide and 0.2 parts by weight of di-t-dodecyl mercaptane are mixed to form a raw material, which is then continuously fed into a stainless steel reactor having a volume of 2 L capable of controlling reaction temperature and agitation. The reactor is maintained at 130° C. with an average retention time of 2 hours, followed by continuously discharging the resultant polymer. The conversion in the reactor is controlled to 35%. The resultant discharged polymer is continuously charged to a second reactor in the series. Simultaneously, 3.8 parts by weight of styrene based on 100 parts by weight of the monomer mixture is continuously added to the second reactor. The second reactor is maintained at 130° C. with an average retention time of 2 hours, followed by continuously discharging the resultant polymer. The conversion in the second reactor is controlled to 35% so that the final conversion becomes 70%. The final resultant polymer from the second reactor is introduced to a devolatilizer controlled at a temperature of 220° C. and a pressure of 20 torr to remove unreacted monomers and solvent, and then pelletized using a pelletizer to obtain a thermoplastic resin in pellet form. The refractive index of the thermoplastic resin measured using a prism coupler manufactured by Metricon Corp. is 1.513, the weight average molecular weight measured using gel permeation chromatography (GPC) is 98,000, the molecular weight distribution is 2.1 and the components of the thermoplastic resin measured using a Elemental Analyzer is styrene 22%, acrylonitrile 3.5% and methyl methacrylate 74.5%.

### Preparative Example 2

Preparative Example 2 is prepared in the same manner as in Preparative Example 1 except that the monomer mixture includes 32 parts by weight of styrene, 58 parts by weight of methyl methacrylate and 10 parts by weight of acrylonitrile, and 6 parts by weight styrene is added to the second reactor. The refractive index of the thermoplastic resin is 1.533, the weight average molecular weight is 95,000, the molecular weight distribution is 2.2 and the components of the thermoplastic resin measured using an Elemental Analyzer are styrene 41%, acrylonitrile 7.5%, and methyl methacrylate 51.5%.

### Preparative Example 3

Preparative Example 3 is prepared in the same manner as in Preparative Example 1 except that the monomer mixture includes 21 parts by weight of styrene, 73 parts by weight of methyl methacrylate and 6 parts by weight of acrylonitrile. The refractive index of the thermoplastic resin is 1.520, the weight average molecular weight is 98,000, the molecular weight distribution is 2.2 and the components of the thermoplastic resin measured using an Elemental Analyzer are styrene 29%, acrylonitrile 4.2%, and methyl methacrylate 66.8%.

### Preparative Example 4

100 parts by weight of a monomer mixture including 18 parts by weight of styrene, 77 parts by weight of methyl methacrylate and 5 parts by weight of acrylonitrile along with 15 parts by weight of ethylbenzene, 0.02 parts by weight of di-t-amyl peroxide and 0.1 parts by weight of di-t-dodecyl mercaptane are mixed to form a raw material, which is then fed continuously into a stainless steel reactor having a volume of 2 L capable of controlling reaction temperature and agitation. The reactor is maintained at 130° C. with an average retention time of 2 hours, followed by continuously discharging the resultant polymer. The conversion of the reactor is controlled to 70%. The resultant polymer is introduced to a devolatilizer controlled at a temperature of 220° C. and a pressure of 20 torr to remove unreacted monomers and solvent, and then pelletized using a pelletizer to obtain a thermoplastic resin in pellet form. The refractive index of the thermoplastic resin is 1.513, the weight average molecular weight is 96,000, the molecular weight distribution is 2.4 and the components of the thermoplastic resin measured using an Elemental Analyzer are styrene 22.5%, acrylonitrile 3.5%, and methyl methacrylate 74%.

### Preparative Example 5

100 parts by weight of a monomer mixture including 22 parts by weight of styrene, 73 parts by weight of methylmethacrylate and 5 parts by weight of acrylonitrile along with 130 parts by weight of ultra pure water, 0.5 parts by weight of sodium lauryl sulfate, and 0.3 parts by weight of 2-2′-azobisisobutyronitrile are mixed to form a raw material, which is then fed into a stainless steel reactor having a volume of 10 L capable of controlling reaction temperature and agitation. The raw material is then polymerized at 75° C. for 3 hours, followed by aging for 1.5 hours at 80° C. The resultant polymer is completely coagulated by dropwise addition of 2% aqueous sulfuric acid under stirring at 70° C., dehydrated, washed and dried to obtain thermoplastic resin in powder form. The conversion is 98.8%. The refractive index of the thermoplastic resin obtained from the above batch process is 1.513, the weight average molecular weight is 95,000, the molecular weight distribution is 2.5 and the components of the thermoplastic resin measured using an Elemental Analyzer are styrene 22.3%, acrylonitrile 4.5%, and methylethacrylate 73.2%.

### Preparative Example 6

Preparative Example 6 is prepared in the same manner as in Preparative Example 1 except that the monomer mixture includes 16 parts by weight of styrene, 79 parts by weight of methyl methacrylate and 5 parts by weight of acrylonitrile. The conversion in the first reactor is controlled to 50% and that of the second reactor is controlled to 20% so that the final conversion becomes 70%. 3 parts by weight of styrene is added to the second reactor. The refractive index of the thermoplastic resin is 1.513, the weight average molecular weight is 96,500, the molecular weight distribution is 2.35 and the components of the thermoplastic resin measured using an Elemental Analyzer are styrene 22%, acrylonitrile 3.5%, and methyl methacrylate 74.5%.

### Preparative Example 7

Preparative Example 7 is prepared in the same manner as in Preparative Example 5 except that the monomer mixture includes 28 parts by weight of styrene, 67 parts by weight of methyl methacrylate and 5 parts by weight of acrylonitrile. The conversion is 98.5%. The refractive index of the thermoplastic resin is 1.520, the weight average molecular weight is 96,000, the molecular weight distribution is 2.5 and the components of the thermoplastic resin measured using an Elemental Analyzer are styrene 28.5%, acrylonitrile 4.5%, and methyl methacrylate 67%.

### Examples and Comparative Examples

### Example 1

65 parts by weight of thermoplastic resin obtained from the Preparative Example 1, 35 parts by weight of butadiene rubber/methyl methacrylate-styrene-acrylonitrile graft copolymer having a refractive index of 1.513, 0.2 parts by weight of IRGANOX 1076 (CIBA-GEIGY) as a thermal stabilizer and 0.1 part by weight of ethylene bis stearamide as a lubricant are mixed and melt-extruded at a temperature of 210° C. to prepare a transparent ABS in pellet form. The transparent ABS is molded into test specimens. The physical properties of the test specimens are measured, and the results are shown in Table 1.

### Example 2

Example 2 is prepared in the same manner as in Example 1 except that 65 parts by weight of thermoplastic resin obtained from the Preparative Example 2 and 35 parts by weight of SBR rubber/methyl methacrylate-styrene-acrylonitrile graft copolymer having a refractive index of 1.533 are used.

### Example 3

Example 3 is prepared in the same manner as in Example 1 except that 65 parts by weight of thermoplastic resin obtained from the Preparative Example 3 and 35 parts by weight of butadiene rubber/methyl methacrylate-styrene-acrylonitrile graft copolymer having a refractive index of 1.513 are used. The results of the physical properties are shown in Table 2.

### Comparative Example 1

Comparative Example 1 is prepared in the same manner as in Example 1 except that 65 parts by weight of thermoplastic resin obtained from the Preparative Example 4 and 35 parts by weight of butadiene rubber/methyl methacrylate-styrene-acrylonitrile graft copolymer having a refractive index of 1.513 are used.

### Comparative Example 2

Comparative Example 1 is prepared in the same manner as in Example 1 except that 65 parts by weight of thermoplastic resin obtained from the Preparative Example 5 and 35 parts by weight of butadiene rubber/methyl methacrylate-styrene-acrylonitrile graft copolymer having a refractive index of 1.513 are used.

### Comparative Example 3

Comparative Example 1 is prepared in the same manner as in Example 1 except that 65 parts by weight of thermoplastic resin obtained from the Preparative Example 6 and 35 parts by weight of butadiene rubber/methyl methacrylate-styrene-acrylonitrile graft copolymer having a refractive index of 1.513 are used.

### Comparative Example 4

Comparative Example 1 is prepared in the same manner as in Example 1 except that 65 parts by weight of thermoplastic resin obtained from the Preparative Example 7 and 35 parts by weight of butadiene rubber/methyl methacrylate-styrene-acrylonitrile graft copolymer having a refractive index of 1.513 are used. The results of the physical properties are shown in Table 2.

The physical properties of the test specimens are measured in accordance with the following methods.

(1) Izod Impact Strength (kgf·cm/cm, ⅛″): The Izod impact strength is measured in accordance with ASTM D-256.

(2) Haze (%): The haze is measured by a Haze meter produced by Nippon Denshoku Co., using a 3 mm thick test sample.

TABLE 1

| | | physical properties of | | | |
|---|---|---|---|---|---|
| | | Thermoplastic resin | | physical properties | |
| | | difference in | a molecular | of transparent ABS | |
| | | refractive index | weight | | Impact |
| | | with rubber phase | distribution | Haze | Strength |
| Example | 1 | 0 | 2.1 | 1.8 | 14.5 |
| | 2 | 0 | 2.2 | 1.9 | 13.8 |
| Comparative | 1 | 0 | 2.4 | 2.4 | 12.2 |
| Example | 2 | 0 | 2.5 | 2.6 | 11.6 |
| | 3 | 0 | 2.35 | 2.3 | 12.5 |

TABLE 2

| | physical properties of | | | |
|---|---|---|---|---|
| | Thermoplastic resin | | physical properties | |
| | difference in | a molecular | of transparent ABS | |
| | refractive index | weight | | Impact |
| | with rubber phase | distribution | Haze | Strength |
| Example 3 | 0.007 | 2.2 | 4.5 | 14.1 |
| Comparative | 0.007 | 2.5 | 12.3 | 11.3 |
| Example 4 | | | | |

As shown in Table 1, the transparent ABS resin of Examples 1-2 in which the thermoplastic resin having uniform composition and narrow molecular weight distribution is employed as a matrix shows good transparency and impact strength. However, the transparent ABS resins of Comparative Examples 1-2 in which the thermoplastic resin having a non-homogeneous composition and broad molecular weight distribution is used as a matrix resin show deterioration in transparency and impact strength, although there is no difference in refractive index between the thermoplastic resin and the rubber phase. This is because when the thermoplastic resin having a high conversion is prepared by a batch process or a continuous process using only one reactor, the compositions of polymer produced from the initial polymerization step may be different from those from the last polymerization step. Accordingly, a minute difference in refractive index may partially occur, even though the average refractive indices are the same, resulting in the decrease of transparency of ABS resin. Further, the impact resistance of the Comparative Examples is degraded, because the wide molecular weight distribution whose weight average molecular weight is similar to that of the Examples may cause low number average molecular weight. Comparative Example 3 in which the conversion rate in one reactor is more than 40% shows poor transparency and impact strength as compared with Examples 1-2 because of its non-homogeneous composition and broad molecular weight distribution, even though there is no difference in refractive index.

As shown in Table 2 in which the difference of refractive index is 0.007, Example 3 using the thermoplastic resin with uniform composition and narrow molecular weight distribution shows better transparency and impact strength than Comparative Example 4. This is because the thermoplastic resin of the present invention has a uniform composition, so that deterioration in transparency due to the difference in refractive index from the rubber phase rarely occurs.

The above Examples and Comparative Examples provide evidence that the transparent ABS resin in which the thermoplastic resin prepared by the present invention is employed as a matrix resin may have good transparency and impact strength.

Many modifications and other embodiments of the invention will come to mind to one skilled in the art to which this invention pertains having the benefit of the teachings presented in the foregoing descriptions. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

What is claimed is:

1. A method for preparing a thermoplastic resin, which comprises consecutively polymerizing a mixed raw material comprising a (meth)acrylic acid alkyl ester, an aromatic vinyl monomer and a unsaturated nitrile monomer in a plurality of serially connected reactors while controlling polymerization conversion in each reactor to be about 40% or less.

2. The method of claim 1, wherein said plurality of reactors comprises at least 2 reactors.

3. The method of claim 1, wherein said plurality of reactors comprises 2 to 6 reactors.

4. The method of claim 1, wherein said polymerization conversion is controlled by controlling at least one of reaction temperature, retention time, type of polymerization initiator, amount of polymerization initiator, or a combination thereof.

5. The method of claim 1, wherein said conversion in each reactor is controlled to be about 15 to about 40%.

6. The method of claim 1, further comprising adding additional monomer between each reactor to uniformly maintain the composition of polymers produced from each reactor.

7. The method of claim 6, wherein adding additional monomer comprises adding at least one of (meth)acrylic acid alkyl ester, aromatic vinyl monomer, unsaturated nitrile monomer or a combination thereof.

8. The method of claim 7, wherein said mixed raw material comprises methyl(meth)acrylate, styrene and acrylonitrile, and wherein adding additional monomer comprises adding styrene.

9. The method of claim 6, wherein adding additional monomer comprises continuously adding additional monomer to a polymer stream between reactors or directly into a reactor.

10. The method of claim 1, wherein said mixed raw material comprises up to about 0.2 parts by weight of a polymerization initiator based on 100 parts by weight of a monomer mixture.

11. The method of claim 1, wherein said mixed raw material comprises up to about 20 parts by weight of a solvent based on 100 parts by weight of a monomer mixture.

12. The method of claim 1, wherein said polymerization conversion is controlled at least in part by maintaining a reaction temperature of about 100 to about 150° C. within each reactor.

13. The method of claim 1, wherein said polymerization conversion is controlled at least in part by using a polymer retention time of about 0.5 to about 3.5 hours within each reactor.

14. A thermoplastic resin prepared according to claim 1, having a weight average molecular weight of about 60,000 to about 150,000, and a molecular weight distribution of about 2.3 or less.

15. The thermoplastic resin of claim 14, wherein said thermoplastic resin comprises about 50 to about 85 parts by weight of (meth)acrylic acid alkylester, about 10 to about 50 parts by weight of aromatic vinyl compound and about 2 to about 15 parts by weight of unsaturated nitrile compound.

16. A transparent ABS resin composition comprising the thermoplastic resin of claim 14.

17. The transparent ABS resin composition of claim 16, wherein said transparent ABS resin composition comprises a rubber/methyl methacrylate-styrene-acrylonitrile graft copolymer.

18. The transparent ABS resin composition of claim 17, wherein the difference between the refractive index of the rubber/methyl methacrylate-styrene-acrylonitrile graft copolymer and the thermoplastic resin is about 0 to about 0.008.

19. The transparent ABS resin composition of claim 17, wherein the difference between the refractive index of the rubber/methyl methacrylate-styrene-acrylonitrile graft copolymer and the thermoplastic resin is about 0 to about 0.002.

20. A transparent ABS resin composition comprising about 50 to about 90% by weight of the thermoplastic resin of claim 14 and about 10 to about 50% by weight of a rubber/methyl methacrylate-styrene-acrylonitrile graft copolymer, wherein said transparent ABS resin composition has a haze of about 0.1 to about 4.5 as measured using a Nippon Denshoku Haze meter and an Izod impact strength according to ASTM D-256 at a sample thickness of ⅛ inch of about 13 to about 35 kgf·cm/cm.
